(19) United States
(12) Patent Application Publication
(10) Pub. No.: US 2021/0354340 A1
(43) Pub. Date: Nov. 18, 2021

(54) DEVICE FOR PRODUCING REINFORCEMENT ELEMENTS FROM MATERIAL IN POWDER FORM

(71) Applicant: RHENOFLEX GMBH, Ludwigshafen (DE)

(72) Inventors: Thorsten Katzenberger, Ludwigshafen/Oggersheim (DE); Henritte Jaerger, Heuchelheim bei Frankenthal (DE)

(73) Assignee: RHENOFLEX GMBH, Ludwigshafen (DE)

(21) Appl. No.: 17/297,756

(22) PCT Filed: Jan. 20, 2020
(86) PCT No.: PCT/EP2020/051286

§ 371 Date: May 27, 2021

(30) Foreign Application Priority Data
Jan. 22, 2019 (DE) 10 2019 200 741.4

(51) Int. Cl. B29C 41/36; B29C 41/46

(52) U.S. Cl. CPC B29C 41/36; B29K 2105/251; B29C 41/46

(57) ABSTRACT

An apparatus for producing reinforcing elements for shoes, bags or orthopedic applications comprises a first powder application apparatus, at least one downstream first compounding device, another second powder application apparatus as well as a second compounding device. Such a modular structure allows for producing different types of reinforcing elements in a simple manner.

### BACKGROUND

### 1. Field of the Invention

The disclosure relates to an apparatus for producing reinforcing elements from a powdery material. The reinforcing elements are in particular reinforcing elements for shoes, bags, orthopedic applications or the like.

### 2. Discussion of the Background Art

For producing reinforcing elements from a powdery and at least partially meltable material, an apparatus is known from WO 2012/059367. Said apparatus comprises a powder container in which a freely flowing and at least partially meltable powder is stored. At an outlet of the powder container, a template is provided which defines the shapes of the reinforcing element. With the aid of a slider, the outlet of the powder container can be opened and closed. The powder freely flows through the template and onto a transport belt, wherein the transport belt is clocked synchronously to the opening and closing of the slider. Adjacent to such a powder application apparatus, a heating device is arranged which, by applying heat and/or pressure, causes the powder to be at least partially melted for producing the reinforcing element.

It is an object of the disclosure to provide an apparatus for producing reinforcing elements, with the aid of which different types of reinforcing elements can be produced in a simple manner.

### SUMMARY

The apparatus according to the disclosure for producing reinforcing elements for shoes, bags, orthopedic applications or the like comprises a first powder application apparatus. The powder application apparatus comprises a first powder container for an at least partially meltable powder mixture. The powder mixture is provided on a feeding device, such as a transport belt. The feeding device may also be a stationary planar device, such as a receiving metal plate or the like. The powder application apparatus further comprises, at an outlet of the powder container, a template for defining a basic shape of a reinforcing element to be produced. With the aid of the template, thus an in particular predefined quantity of the powder mixture is applied, in a basic shape, onto the feeding device. The powder quantity can be defined by a slider or another dosing apparatus. The powder mixture can consist of several powders of different materials, different sizes etc. At least one of the powder materials is meltable.

Further, the apparatus according to the disclosure comprises a first compounding means downstream of the powder application apparatus. With the aid of the compounding means, thus in a step following the powder application, the powder is compounded. The first compounding means can comprise a heating device, for example, for causing the at least partially meltable powder material to be incipiently melted or melted. With the aid of a first compounding means, a fluid could also be added to the powder for at least loosely compounding it. The first compounding means is preferably configured such that it supplies heat to the powder mixture for incipiently melting or melting at least one constituent of the powder mixture. The heat can be introduced into the material by a laser, heat radiation of a lamp and/or another heating device, such as a heating plate or a heating die, for example.

According to the disclosure, a second powder application apparatus is arranged downstream of the first compounding means. After the powder mixture has been at least loosely compounded by the first compounding means, another powder mixture is provided with the aid of the second powder application apparatus. Like the first powder application apparatus, the second powder application apparatus also comprises a powder container and a template located at the outlet of the powder container. The second powder application apparatus provides a powder in such a way that it is at least partially arranged in the basic shape and that a powder layer applied by the second powder application apparatus at least partially covers the layer produced by the first powder application apparatus. Thereby, it is possible, in a simple manner, to produce a reinforcing element having differently thick areas. The second powder container of the second powder application apparatus can be identical with the first powder container such that the powder mixture from the first powder container is provided by the second powder application apparatus. If necessary, an additional powder material can be admixed such that the material composition of the powder mixture provided by the second powder application apparatus differs from that provided by the first powder application apparatus. It is however preferred that two separate powder containers are provided such that, in a simple manner, even different powder mixtures of different compositions and different free-flowing properties and the like can be provided.

In addition, the apparatus according to the disclosure for producing reinforcing elements comprises a second compounding means downstream of the second powder application apparatus. The second compounding means serves for compounding the powder mixture provided on the feeding device in the preliminary final shape. The preliminary final shape of the reinforcing element to be produced is defined by the second powder application apparatus. The second compounding means then preferably completely compounds the powder material. This is preferably performed again by introducing heat and/or pressure such that preferably all meltable constituents of the powder mixture are melted and form a solid compound. It is preferred that, like the first compounding means, the second compounding means, too, comprises heating devices. In the case of the second compounding means it is particularly preferred that the heating devices comprise heating dies. The heating dies are configured such that they not only introduce heat into the powder mixture to be melted but also exert pressure. Preferably, the heating dies comprise a recess which is complementary to the outer contour of the reinforcing element to be produced. Thus the die defines the final shape of the reinforcing element. According to a particularly preferred embodiment, the second compounding means comprises at least one heating device and at least one heating die. The heating device, such as a furnace or the like, heats the powder mixture such that at least meltable constituents are incipiently melted or melted. The preferably several heating dies cause an in particular complete melting of the meltable constituents of the powder mixture and define the final shape of the reinforcing element.

The flowability of the powder mixture used is preferably in the range from 20 to 30 secs., measured with a 10 mm nozzle as per EN ISO 6186.

According to a particularly preferred embodiment of the disclosure, an arrangement apparatus is provided between the first powder application apparatus and the first compounding means and/or between the first compounding means and the second powder application apparatus. The arrangement apparatus, which can be a robot arm (pick and place) or the like, for example, serves for arranging intermediate elements on the powder mixture applied onto the feeding device by the first powder application apparatus. Here, intermediate elements can be placed either before and/or behind the first compounding means.

The intermediate elements can be fabric, textile materials, textile fabric or the like, for example. Further, the intermediate elements can be arranged as grid structures or grid elements in particular produced by a 3D-printing process. Further, intermediate elements can be produced by spray processes or arranged or sprayed onto the powder mixture already provided on the feeding device. Corresponding structures can thus be produced by spraying-on powder or other materials. The intermediate elements in particular serve for additional reinforcement of the reinforcing elements. The intermediate elements are in particular elements into which the melting powder mixture penetrates. Here, the in particular planar intermediate elements can partially or completely cover the upper side of the powder provided on the feeding device in a basic shape. Further, a plurality of partially overlapping intermediate elements can be arranged. Hence, the arrangement apparatus can comprise one or a plurality of robot arms, for example.

In another preferred embodiment of the apparatus according to the disclosure for producing reinforcing elements, an arrangement apparatus for arranging additional elements is provided between the first compounding means and the second powder application apparatus and/or between the first powder application apparatus and the first compounding means. Preferably, the additional elements are storage elements, such as active or passive chips, in particular RFID chips. Such additional elements can be provided additionally to or instead of intermediate elements.

According to the disclosure, the apparatus for producing reinforcing elements can thus comprise, in addition to the two powder application apparatus and the two compounding means, arrangement apparatus at different locations for arranging intermediate elements and/or for arranging additional elements. Thus, a modular structure or a modular use of the apparatus according to the disclosure for producing different reinforcing elements with different properties is possible. In particular, multi-layer reinforcing elements with different material thicknesses, different material compositions, different intermediate elements and/or different additional elements can be produced in a simple manner.

According to a preferred embodiment of the disclosure, a compressing and/or calibrating means can be provided downstream of the second compounding means. Such a compressing and/or calibrating means can be integrated in the second compressing means, which is a heating means, for example, or can define a common station together with said compressing means. With the aid of such a device in particular the thickness of the product can be definitely calibrated. This is in particular realized by plastic deformation of the still hot powder material or the powder material having a temperature which allows for a plastic deformation. Such a device can comprise rollers, belts, dies, presses or the like.

Further, it is possible that such a compressing and/or calibrating means is combined with a cooling means or is arranged between a heating means and a cooling means.

According to a preferred embodiment, a coating and/or metal detection means can be provided downstream of the second compounding means whereby further means can be interposed. With the aid of the coating means the product can be labeled by a print head, by a laser or the like, for example.

With the aid of a metal detection means the produced products can be sorted, for example. In addition, it is possible to provide a means for quality control, in particular for an automatic quality control.

It is in particular preferred to provide a programming means in this area with the aid of which it is possible to program programmable intermediate elements, such as chips or the like, immediately after the production of the reinforcing elements. Further, a sorting means as well as possibly an automatic removal means and/or an automatic tracking means can be provided in this area.

The feeding device, which preferably comprises at least one conveyor belt, can have a single-piece or multi-piece configuration. In particular, the individual stations, which are preferably connected to each other by conveyor belts, can be linearly arranged in series such that an apparatus corresponding to an elongate production line is realized. It is further possible to arrange individual stations at an angle to each other and/or opposite each other. Thus, the individual stations are essentially, at least partially, arranged in a circle or at an angle to each other. Thereby, the apparatus according to the disclosure can be adapted to local conditions.

In particular when the feeding device comprises conveyor belts, said belts may be Teflon-coated. This is in particular advantageous for preventing powder from sticking. In particular powder, which is incipiently melted or melted, would stick to non-coated transport belts, wherein this situation can be avoided by a Teflon coating.

According to a preferred embodiment of the disclosure, a cooling means is arranged downstream of the second compounding means. The cooling means can comprise cooling dies such that a purposeful cooling of the reinforcing elements is possible. Following the cooling process, an item number or the like can be applied to the reinforcing element by a laser printing process, for example. Adjacent thereto, a means for metal detection can be provided.

The disclosure will be described hereafter in more detail with reference to preferred embodiments and the accompanying drawings.

### BRIEF DESCRIPTION OF THE DRAWINGS

In the Figures:

FIG. 1 shows a schematic, strongly simplified side view of a first preferred embodiment of the apparatus for producing reinforcing elements, and

FIG. 2 shows a strongly simplified top view of a second embodiment of the apparatus for producing reinforcing elements.

### DETAILED DESCRIPTION OF THE PREFERRED EMBODIMENT

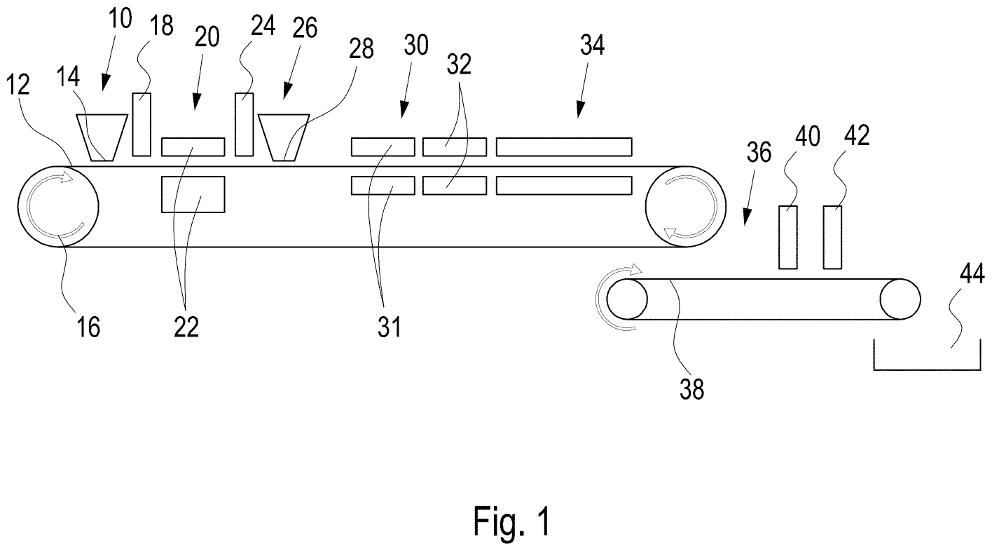

In the strongly simplified schematic side view illustrated in FIG. 1, an at least partially meltable powder mixture is provided via a first powder application means 10. For this purpose, a powder container of the powder application apparatus 10 comprises, at an outlet 14, a template for defining a basic shape of a reinforcing element to be produced. For defining the powder quantity to be dosed, a slider or another dosing means can be provided. The powder mixture is applied onto the upper side of a feeding device configured as a transport belt in the illustrated exemplary embodiment. Thus, on the transport belt 12, the basic shape of a reinforcing element to be produced is provided.

In an arrangement apparatus 18 arranged downstream of the first powder application apparatus, as seen in the transport direction 16, intermediate elements can be arranged. Intermediate elements, such as fabric, textile fabric or other elements can be arranged as intermediate elements on the upper side of the already applied powder layer.

Downstream of the arrangement apparatus 18, again as seen in the transport direction 16, a first compounding means 20 is provided. In the illustrated exemplary embodiment, the compounding means comprises heating devices 22 which are provided on both sides of the transport belt 12. The heating devices cause the meltable constituents of the powder mixture to at least partially melt such that at least a loose compounding of the powder mixture is ensured.

Downstream of the first compounding means, again as seen in the transport direction 16, another arrangement apparatus 24 is provided. With the aid of this arrangement apparatus 24, additional elements, such as storage components or the like, can be arranged on the upper side of the powder layer produced by the first powder application apparatus 10. Subsequently, with the aid of a second powder application apparatus, another layer of powder mixture is applied onto the first powder layer. The second powder application apparatus preferably comprises a powder container having a template arranged at an outlet 28. The powder layer applied by the second powder application apparatus 26 at least partially covers the powder layer applied by the first powder application apparatus 10. If the arrangement apparatus 18 and/or 24 apply intermediate elements or additional elements, it is preferred that these elements are completely covered by the second powder layer.

Downstream of the second powder application apparatus 26, again as seen in the transport direction, a second compounding means 30 is arranged. The compounding means 30 schematically arranged in the illustrated exemplary embodiment is a compounding means comprising heating devices 31 located opposite each other. The heating devices 31 may be heating plates, heat radiators, heating furnaces or the like. In the illustrated exemplary embodiment, further heating devices 32 are arranged downstream of the heating devices 31. Preferably, the heating devices 32 are heating dies which are preferably configured to be displaced vertically to the transport belt. Preferably, the heating dies allow pressure and heat for melting and producing the reinforcing elements to be simultaneously applied. Thereafter, the reinforcing elements are cooled by a cooling means 34 which may comprise cooling dies.

Behind the second powder application apparatus 26, as seen in the transport direction, one or a plurality of compressing and/or calibrating means can be provided. They can be arranged between the heating devices 30, 32 and the cooling device 34, in front of these devices or in combination with the corresponding devices.

In an area 36, the reinforcing elements arranged on the upper side of the transport belt 12 fall onto a second transport belt 38 arranged vertically beneath the transport belt 12. With the aid of a writing means 40, such as a laser printer, an item number or the like can be applied to the reinforcing elements. Thereafter, a metal detector can determine the produced reinforcing elements which then fall into a transport container 44.

In this area a programming means for programmable intermediate devices arranged in the reinforcing elements can be further provided. In addition, a sorting means, a packing means and the like can be arranged here.

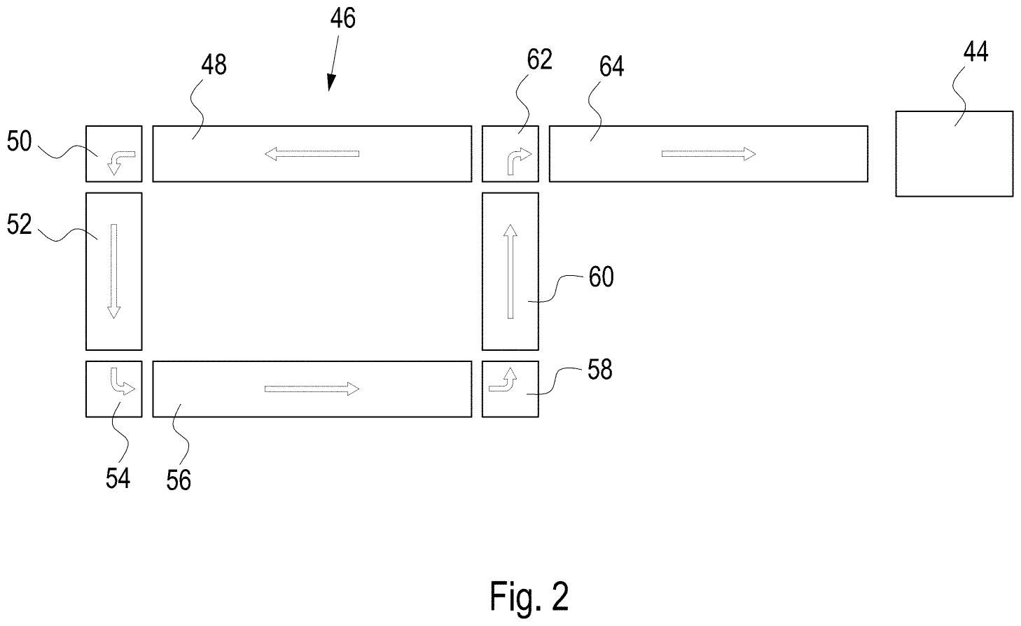

In an alternative embodiment a schematic top view of which is illustrated in FIG. 2, the individual stations illustrated in FIG. 1 are also present, but arranged in a different way. In a section 46, a transport belt 48 serving as a portion of a feeding device is arranged. Above said transport belt, in the area 46, the first powder application apparatus 10, the arrangement apparatus 18, the first compounding means 20, the arrangement apparatus 28 as well as the second compounding means 30 are arranged one after the other from right to left or in the transport direction. According to the embodiment illustrated in FIG. 1, the compounding means 30 preferably comprises heating devices 31, such as a heating furnace, and heating devices 32, such as heating dies, for example. With the aid of a redirection device 50 adjacent to the transport belt 48, the produced reinforcing elements are redirected in the illustrated manner and conveyed to another transport belt 52. In the area of the transport belt 52, the second compounding means 30 is arranged. Another redirection device 54 redirects the reinforcing elements onto a transport belt 46. In this area, the cooling means 34 is arranged. Here, instead of the cooling means 34, another heating means can be provided. The adjacent redirection device 58 redirects the reinforcing elements onto another transport belt 60, wherein, depending on the configuration, in the area of the transport belt 60, the cooling means 34 or possibly another cooling means can be provided. Via another redirection device 62, the reinforcing elements are transported onto a transport belt 64 which corresponds to the transport belt 38 and in this area the writing units 40 and the detection means 42 can be arranged. The reinforcing elements are then conveyed into the container 44.

1. An apparatus for producing reinforcement elements, in particular for shoes, bags or orthopedic applications, comprising
a first powder application apparatus having a first powder container for an at least partially meltable powder mixture, for providing a powder mixture on a feeding device and, provided at an outlet of the powder container, a template for defining a basic shape of a reinforcing element to be produced,
a first compounding device arranged downstream of the first powder application apparatus for compounding the powder mixture provided in the basic shape on the feeding device
a second powder application apparatus arranged downstream of the first compounding device and having a second powder container for an at least partially meltable powder mixture, for providing a powder mixture at least partially on the basic shape with the aid of a template provided at an outlet of the second powder container for defining a preliminary final shape of a reinforcing element to be produced, and
a second compounding device arranged downstream of the second powder application apparatus for compounding the powder mixture provided in the preliminary final shape on the feeding device.

2. The apparatus for producing reinforcing elements according to claim 1, wherein the first and/or the second compounding devices comprise heating devices for at least partially melting the powder mixture.

3. The apparatus for producing reinforcing elements according to claim 1, wherein between the first powder application apparatus and the first compounding device and/or between the first compounding device and the second powder application apparatus, an arrangement apparatus for arranging intermediate elements is provided.

4. The apparatus for producing reinforcing elements according to claim 3, wherein the intermediate elements are configured such that a powder mixture penetrates interspaces of the intermediate elements during the melting process.

5. The apparatus for producing reinforcing elements according to claim 1, wherein between the first compounding device and the second powder application apparatus and/or between the first powder application apparatus and the first compounding device an arrangement apparatus for arranging additional elements is provided.

6. The apparatus for producing reinforcing elements according to claim 1, wherein the second compounding device comprises at least one heating device which defines the final shape of the reinforcing elements.

7. The apparatus for producing reinforcing elements according to claim 1, wherein the feeding device comprises a conveyor belt.

8. The apparatus for producing reinforcing elements according to claim 1, wherein, downstream of the second compounding device, compressing and/or calibrating devices and/or a cooling device are arranged.

9. The apparatus for producing reinforcing elements according to claim 8, wherein the compressing and/or calibrating devices and the heating device of the second compounding device are configured as a unit, and/or that the compressing and/or calibrating devices and the cooling device are configured as a unit.

10. The apparatus for producing reinforcing elements according to claim 8, wherein downstream of the second compounding device and the cooling device a coating device and/or a metal detector are arranged.

11. The apparatus for producing reinforcing elements according to claim 8, wherein downstream of the second compounding device and the cooling device a programming means for programming programmable intermediate elements arranged by one of the arrangement apparatus is provided.

12. The apparatus for producing reinforcing elements according to claim 1, further comprising individual stations of the apparatus that are linearly arranged in series.

13. The apparatus for producing reinforcing elements according to claim 1, further comprising individual stations of the apparatus that are partially arranged at an angle to each other and/or opposite each other.
